(19) United States
(12) Patent Application Publication
(10) Pub. No.: US 2007/0162337 A1
(43) Pub. Date: Jul. 12, 2007

(54) METHOD AND SYSTEM FOR DISTRIBUTING AND REDEEMING TARGETED OFFERS TO CUSTOMERS

(76) Inventors: Gary Hawkins, Skaneateles, NY (US); Janusz Niemiec, Manlius, NY (US); Brown H. Carpenter, San Francisco, CA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/566,948

(22) Filed: Dec. 5, 2006

Related U.S. Application Data
(63) Continuation-in-part of application No. 11/283,202, filed on Nov. 18, 2005.
(63) Continuation-in-part of application No. 11/421,458, filed on May 31, 2006.
(60) Provisional application No. 60/742,743, filed on Dec. 5, 2005.

(51) Int. Cl. G06Q 30/00

(52) U.S. Cl. 705/14

(57) ABSTRACT

Methods and systems are provided for activating and redeeming product discount offers targeted to particular customers. Information related to a merchant loyalty program such as t-logs, customer loyalty information, redemption history, customer segmentation data, and merchant product taxonomies are regularly transmitted to an incentive management system for storage. Merchants can then generate pools of offers and submit them to the incentive management system, which analyzes the characteristics of the offers and uses the information related to the merchant loyalty program to target the offers to specific customers most likely to redeem such offers.

### CLAIM OF PRIORITY

This application is a continuation-in-part of U.S. application Ser. No. 11/283,202 filed Nov. 18, 2005 and a continuation-in-part of U.S. application Ser. No. 11/421,458 filed May 31, 2006. This application also claims priority benefit under 35 U.S.C. § 119(e) from provisional application No. 60,1742,743 filed Dec. 5, 2005. All of the foregoing applications are hereby incorporated by reference herein, in their entirety, for all purposes.

### TECHNICAL FIELD

The disclosed embodiments pertain to merchant loyalty programs, and more specifically, to delivering and redeeming targeted offers to customers who have enrolled in such merchant loyalty programs.

### BACKGROUND

Forces within the mass retail industry are creating increasing pressure on manufacturers, distributors/wholesalers and retailers. A tremendous amount of consolidation has occurred and continues to occur in the industry at the retail level. Competition has also led to an increase in channel blur, whereby retailers are selling products outside of their traditional channels in search of increased sales. Manufacturers and retailers alike have been hard hit by the commoditization of branded goods and products.

In addition to these forces internal to the industry, external pressures affect the marketing of goods throughout the supply chain. The cost of mass media advertising and marketing for manufacturers and retailers alike continues to increase significantly while providing less of a return. The increasing splintering of traditional mass media vehicles (i.e., going from three major television channels some years ago to hundreds today) means that the cost of reaching an equivalent audience size has substantially increased.

The advent of retail frequent shopper programs has provided the retail industry greater insight into customer shopping behavior. It has been determined that 30% of customers generate approximately 75-80% of a retail company's annual sales with the bottom 30% of customers (when ranked by spending) generating less than 3% of annual sales. Many retail companies also have tremendous turnover occurring in their customer base, losing a great many shoppers each year. Furthermore it has been commonly found that retailers' regular patrons actually subsidize deals and loss-creating offers for occasional, deal-seeking customers.

Concurrent with these developments in retail, a customer trend has moved to on-line shopping. The internet has revolutionized customer buying habits, including opening a new portai that transcends geographic limitations and allows for purchasing 24 hours, 7 days a week. The online world provides retailers with access to millions of customers. With the ability to communicate freely to customers, retailers can easily target specific customers by sending them product-specific promotions, coupons, and the like. However, with the Internet quickly growing as a preferred channel for customer purchasing, the on-line shopping arena misses out on opportunities to compete with loyalty-based reward or incentive programs as offered in stores. Furthermore, there is a gap between the on-line and offline market thereby allowing merchants to be effective either on-line or in stores, but not both.

Accordingly, there is a need for a method that combines the benefits of physical and virtual commerce to identify and market to specific customers and customer groups. Additionally, there is a need for providing loyalty programs that can be used either online or in stores.

### SUMMARY

The present disclosure teaches a method for redeeming targeted offers for a customer at a merchant location comprising obtaining a merchant loyalty identifier such as a loyalty number relating to the customer, locating in a database a set of personal incentives (as further detailed below) targeted for the customer, transmitting data elements relating to each personal incentive in the set to a redemption controller located at the merchant location, receiving at the redemption controller a product code relating to a product scanned at a merchant point of sale, determining at the redemption controller whether the product code matches any of the data elements (e.g., UPC code, discount price, etc.) for any personal incentive in the set, and transmitting the discount information relating to the product to the merchant point of sale.

The present disclosure also teaches a method for activating targeted offers for a customer comprising obtaining a merchant loyalty identifier relating to the customer, locating in a database a set of personal incentives targeted for the customer, transmitting information (e.g., discount price, product description, etc.) relating to each personal incentive in the set to a customer display; and marking the personal incentives in the set as activated.

The present disclosure also teaches an incentive management system to the foregoing redemption and activation methods. Such an incentive management system may comprise a merchant loyalty program subcomponent for storing merchant information (e.g., customer loyalty information, transaction log (t-log) information, product taxonomies, customer segmentation data, etc.) relating to a merchant loyalty program, a communication staging server for transmitting personal incentives to customers for activation and for transmitting personal incentives to a redemption controller at a merchant location to facilitate redemption by customers, a targeting engine for generating targeted offers of personal incentives for customers based upon analysis of the characteristics of the personal incentives and the merchant information stored by the merchant loyalty program; and a targeted offers database for storing the targeted offers generated by the targeting engine.

### BRIEF DESCRIPTION OF THE DRAWINGS

The accompanying drawings, which are incorporated in and form a part of the specification illustrate various embodiments and, together with the description, serve to explain the principles of the various embodiments.

FIG. 1 depicts an exemplary biometrically enhanced infrastructure architecture in which an incentive management system may be utilized.

FIG. 2 depicts an exemplary component architecture for an incentive management system,

FIG. 3 depicts a flow chart for activating targeted offers through the incentive management system.

FIG. 4 depicts a flow chart for redemption of targeted offers through the incentive management system of the present invention.

### DETAILED DESCRIPTION

Various embodiments of the invention are discussed in detail below. While specific implementations are discussed, it should be understood that this s done for illustration purposes only. A person with ordinary skill in the relevant art will recognize that other components and configurations can be used without parting from the spirit and scope of the invention.

The present disclosure relates to a system and method for electronically distributing and redeeming product coupons and other types of product offers for targeted customers (“personal incentives”). For example a personal incentive may be a advertisement, coupon or offer presented to a customer by a retail merchant or a manufacturer (such manufacturer also Known as a “CPG” or a “Consumer Packaged Goods” in certain industries) for a discount off the regular price of the product. Such a personal incentive may have certain associated rules and restrictions, including a limit per customer, a maximum number distributable to all customers and a customer segment profile which customers must satisfy to be offered such personal incentive (e.g., spend level of a customer, frequency of visits of a customer, etc.). Enrollment with an incentive management system as further described herein enables a customer to receive such personal incentives through various distribution channels and redeem such personal incentives electronically at a merchant's “brick and mortar” location and/or virtual point of sale.

Infrastructure Architecture

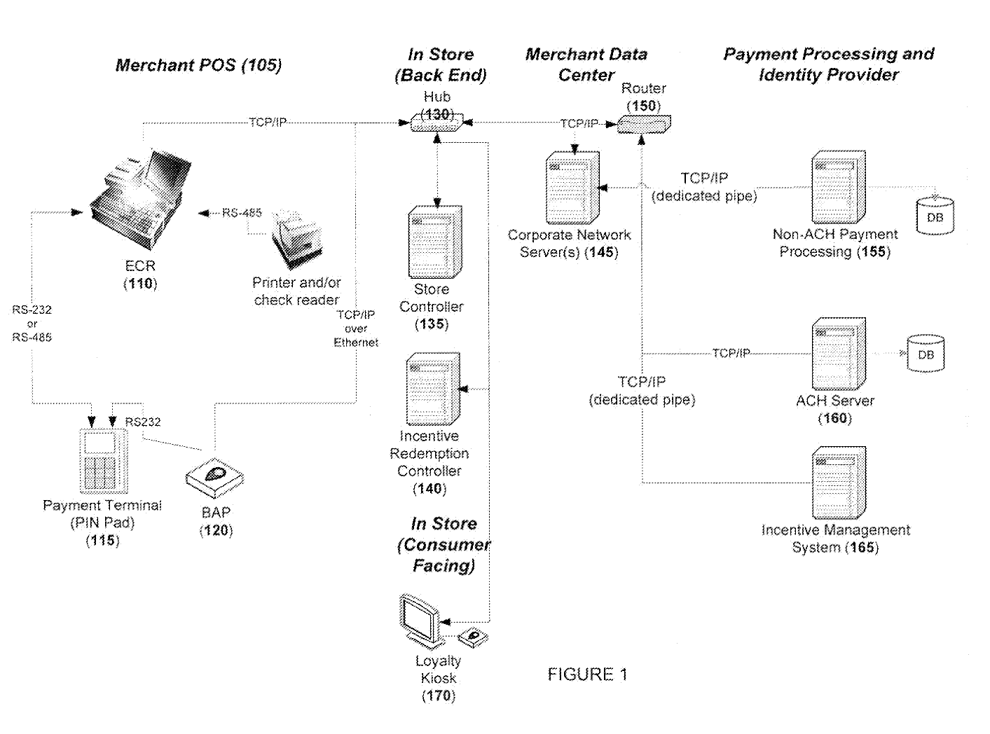

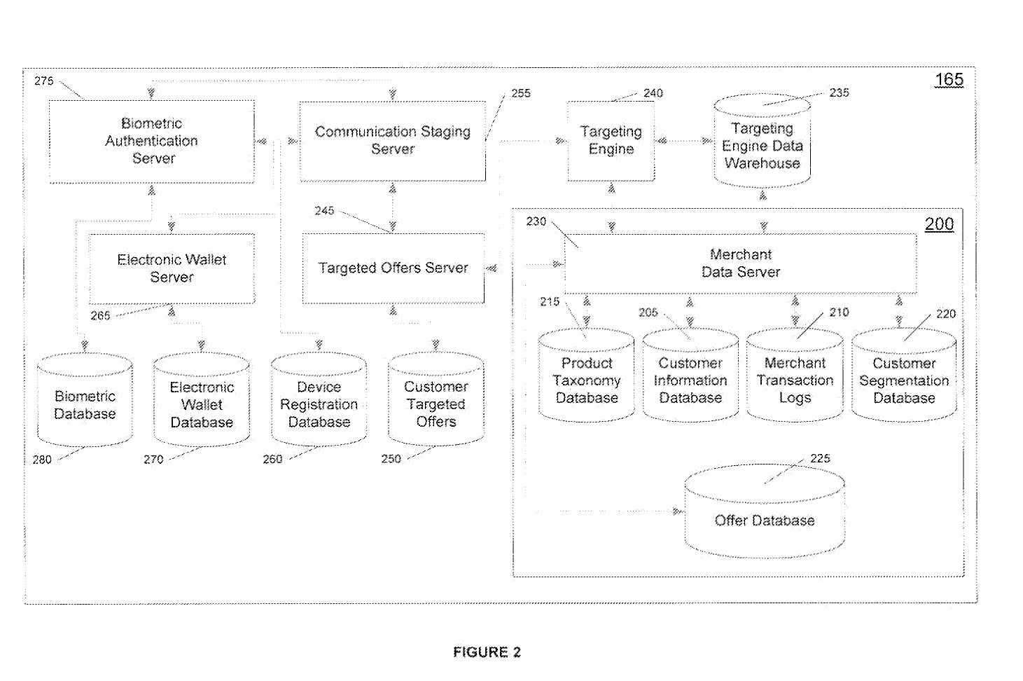

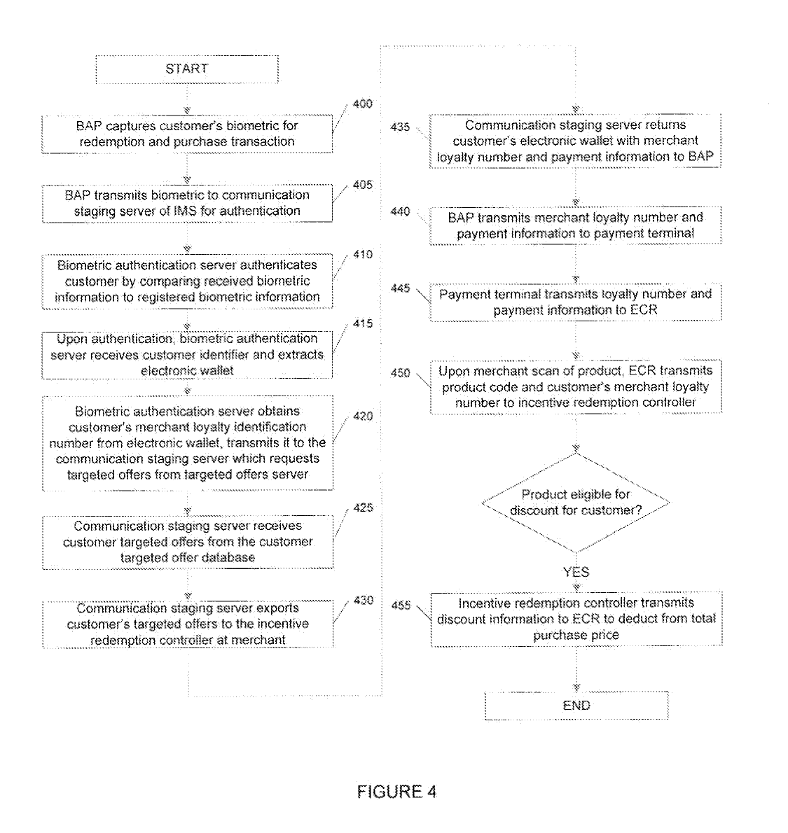

FIG. 1 depicts one embodiment of a biometrically enhanced infrastructure architecture for activating and redeeming personal incentives and conducting biometric payment transactions at a merchant location in which the present invention may be deployed. A merchant's point of sale (“POS”) 105 may include an electronic cash register (“ECR”) 110 that is coupled to a PIN pad 116 which is further coupled to a biometric access point (“BAP”) 120. In addition to providing a biometric scanner, the BAP 120 may also contain a processor, memory and software in order to control biometric image capture at the biometric scanner as well as drive or respond to communication from the PIN pad 115 or the incentive management system 165 (“IMS”) (as further detailed below). The ECR 110 may be further coupled to other peripherals devices such as a printer or check reader that provides further POS functionality. Both the ECR 110 and the BAP 120 (and the other SAP and ECRs for other POS stations if the merchant has multiple check-out lanes, such as in a supermarket) may be further coupled through a hub 130 to the merchant's specific store controller 135 and a incentive redemption controller 140 (as further described in conjunction with FIG. 4). The ECR 110 may be configured or customized to communicate with the incentive redemption controller 140 as further described during the redemption process in FIG. 4. The hub 130 may be further coupled to the merchant's cross-store corporate-wide network server 145. The corporate-wide network server 145 may be further coupled to a router 150 which may be further coupled to payment processing services for credit or debit card transactions 155 or for Automated Clearing House (“ACH”) checking transactions 160. The corporate-wide network server 145 may also be further coupled to the IMS 165. A biometrically accessible loyalty kiosk 170 may also be placed at the merchant to provide customers the opportunity to view and activate their personal incentives prior to initiating their shopping experience. Such a loyalty kiosk 170 may also be coupled, via the hub 130 and router 150, ultimately to the IMS 165, which as further described in FIG. 2, may contain a database of personal incentives that may be presented to the customer for viewing and “activation” at the loyalty kiosk 170.

Those of ordinary skill in the art will recognize that the various communication channels and computer systems depicted in FIG. 1 may be implemented in a variety of known techniques and manners. For example, while the loyalty kiosk 170 is illustrated as being coupled to the merchant's in store network hub 130, in certain embodiments, the loyalty kiosk 170 may posses its own direct communication channel to the IMS 165 that is separate from the merchant network. With respect to network connections, rather than using dedicated TCP/IP connections between the corporate-wide network server 145 and the IMS 165 and other payment processors 155 and 160, Internet connections may be considered in alternative embodiments. Similarly, rather than having the BAP 120 communicate with the IMS 165 through a wired network, alternative embodiments may utilize a wireless network system for communication between the BAP 120 and the IMS 165. Similarly, if the merchant's in-store computer network supports wireless networking technology, the ECR 110 may communicate with the store controller 135 wirelessly. As those of ordinary skill in the art will recognize, the communication among the merchant's POS 105, the in-store controller 135, the incentive redemption controller 140, the merchant's corporate-wide network server 145, various payment processing servers 155 and 160 and the IMS 165 may be implemented through a variety of private or proprietary networked connections or through the Internet or other publicly accessible networks. Those of ordinary skill in the art will recognize that the control logic and data stored and used by the various computer systems as described above is merely illustrative and may be distributed throughout the various computer systems' logic controls and databases in alternative but functionally equivalent designs, including without limitation, the removal of certain systems and addition of other systems, without departing from the scope or spirit of the described embodiments. For example, a biometric scanner device (without the additional processing, memory and software capabilities of a BAP 120) may be coupled directly to the ECR 110 and the logic for communication between the biometric scanner device and the IMS 165 may be managed by the addition of another server coupled to the store controller 135 in the back of the merchant's location. An alternative embodiment, for example, for a smaller merchant or business, may not utilize a store controller 135 or have a corporate-wide network series 145.

IMS Architecture

FIG. 2 depicts an exemplary component architecture for an IMS 165 capable of generating personal incentives and electronically communicating these personal incentives to customers, and enabling electronic redemption of these personal incentives at points of redemption such as the merchant POS 105. The IMS 165 includes a merchant loyalty program subcomponent 200 which manages data provided by the merchant to the IMS 165. For each merchant coupled to the IMS 165 (as identified through a merchant identifier), the merchant loyalty program, subcomponent 200 maintains the merchant's customer intonation in customer information database 205 Such customer information may include demographic information (name, address, etc.) as well as the customer's merchant loyalty identification number Similarly, the merchant loyalty program subcomponent 200 may also maintain a merchant transaction logs database 210 that receives and keeps track of all the t-logs generated by the merchant, a product taxonomy database 215 that provides product related codes, product names, unit price, relationships among the various products, etc., for the merchant's inventory, and customer segmentation database 220 that provides spending level information for each of the merchant's customers as identified by their merchant loyalty identification numbers. The foregoing databases are kept up-to-date by regular file transmission updates from the merchant's own systems, for example, on a daily or weekly batch basis, depending upon the embodiment. The merchant loyalty program subcomponent 200 also maintains an offer database 225 that maintains and organizes personal incentives as created by the merchants. For example, while not depicted in FIG. 2, IMS 165 may provide a web interface to the merchant loyalty program subcomponent 200 for merchant employees to manually create and store into offer database 225 personal incentives and pool them, if desired, into sets with common characteristics (e.g., effective date, expiration date, publication date, etc.) (an “offer pool” of personal incentives). As previously discussed, a personal incentive may be a coupon or offer for a discount off the regular price of a product. Such a personal incentive may have certain rules and restrictions associated therewith, including a limit per customer, a maximum number distributable to all customers, and a customer segment profile (e.g., spend of a customer, frequency of visits of a customer, etc.) which customers must satisfy to be offered such personal incentive. Additionally, each personal incentive may have a “targeting strategy” associated with it. A particular targeting strategy typically defines a particular “reference group” of products against which the customer's prior purchasing behavior may be analyzed to assess the interest of such a customer in particular personal incentive. Generally, if the customer rarely purchases any of the products in the reference group, he is assumed to have a low interest in the product related to the personal incentive. If the customer is a frequent purchaser of products in the reference group, he is assumed to have a high interest in the personal incentive. The creation of reference groups of products may be a manual merchant process given the need for the merchant s understanding of its own business and customers. When the merchant creates a personal incentive for a product through the web interface of the IMS 165, the merchant may also select a particular target strategy to assign to the personal incentive. For example, a “reward” strategy may simply utilize the product that is the subject of the personal incentive itself as the reference group (i.e., a customer's prior purchase of a product is a good indicator that he may be interested in purchasing the product in the future); a “category” strategy defines its reference group as all products that are in the same product taxonomy as the product that is the subject of the personal incentive (i.e., if a customer has purchased a product in the same product taxonomy as that of the product of the personal incentive, he may likely have some interest in the personal incentive as well); and an “upsell” strategy may define its reference group as products in the same taxonomy that have a lower price than the price of the product that is the subject of the personal incentive (i.e., customers may purchase a more expensive but similar product if it is discounted through a personal incentive).

A merchant data server 230 may he coupled to each of the customer information database 205, merchant transaction logs database 210, product taxonomy database 215, customer segmentation database 220 and offer database 225 and may serve as a management gateway (e.g., in order to properly segregate data received from different merchants) for merchant systems that transmit merchant-related data to the various databases of merchant loyalty program subcomponent 200 as well as for other components of the IMS 165 that may request or otherwise receive information from the merchant loyalty program subcomponent 200. In one embodiment, on a scheduled basis (e.g., daily for some databases, weekly or longer for other databases), the merchant loyalty program subcomponent 200, through the merchant data server 230 may transmit updated customer information, t-logs, product taxonomies, and customer segmentation information to a targeting engine data warehouse 235 that is coupled to a targeting engine 240. A merchant employee, may then, for example through the merchant's web interface initiate the transmission of a created offer pool to the target engine. In alternative embodiments, an offer pool may have a defined targeting date on which the merchant data server 235 automatically transmits the offer pool to the targeting engine 240.

The targeting engine 240 conducts a matchmaking process between the personal incentives in the offer pool and the merchant's customers. Upon receiving the offer pool for targeting for the merchant data server 230, the targeting engine 240 extracts the particular merchant's information (e.g., offers, t-logs, product taxonomies, customer information, customer segmentation information, etc.) that is stored in the targeting engine data warehouse 235 and referenced, for example, by a merchant identifier. For each personal incentive in the offer pool, the targeting engine 240 may then calculate the relevance score for each merchant customer based, in part, upon the customer's and other customers' purchasing behavior as indicated through the t-logs and other merchant information from the targeting engine data warehouse 235, assign rankings of the offers to the merchant's customers based on such relevance scores, and allocate the personal incentives to selected customers who have the highest chance of redeeming such personal incentives. One example of a methodology for calculating such relevance scores and assigning personal incentives to customers is set forth in U.S. patent application Ser. No. 10/616,486 filed Jul. 8, 2003 which is hereby incorporated by reference in its entirety. Once the targeting engine 240 has targeted the personal incentives to merchant customers, the targeting engine 240 transmits such personal incentives-customer associations (hereinafter, the “targeted offers”) to the targeted offers server 245 which stores them in the customer targeted offers database 250. Such targeted offers are then ready to be extracted from the customer targeted offer database 250 when requested by the communication staging server 255 (through targeted offers server 245) when “activated” by a customer at a merchant loyalty kiosk 170 and when redeemed by the customer at a merchant POS 105 as further detailed below.

Certain embodiments of the IMS 165 may further contain a device registration database 260 that is coupled to the communication staging server 255 and contains customers' mobile device identifiers (obtained during a customer enrollment process), such as a cell phone number, in the event that the customer chooses to activate targeted offers through his mobile device. Such device registration database 260 may associate a customer's mobile device identifier with a custom,er identifier such as the customer's merchant loyalty identification number or other internal customer identifier which would enable the targeted offers server 245 to extract the appropriate targeted offers for the customer in the customer targeted offer database 250 for transmission to the customer's mobile device for viewing and activation.

An exemplary embodiment of an IMS 165 may be further capable of authorizing a customer biometrically for a payment transaction at the merchant POS 105. Such embodiments of the IMS 165 may include an electronic wallet server 265 that provides access to customer's electronic wallets stored in the electronic wallet database 270 and a biometric authentication server 275 that provides access to a customer's registered biometric samples stored in biometric database 280. The electronic wallet server 265 and a biometric authentication server 275 enable a customer at a merchant POS 105 to utilize the BAR 120 to submit a biometric sample in order to retrieve payment information from the customer's electronic wallet stored at the IMS 165 to provide for the payment terminal 115 to process the payment at the merchant POS 105 and ultimately send to a payment processor such as 155 or 150. Exemplary embodiments of biometric payment systems are described in U.S. application Ser. No. 11/421,451, filed May 31, 2006, which is hereby incorporated by reference in its entirety.

Those of ordinary skill in the art will recognize that the logical components and databases described in IMS 165 of FIG. 2 are merely illustrative and may be distributed in alternative but functionally equivalent designs, including without limitation, the removal of certain components and addition of others without departing from the scope or spirit of the described embodiments. For example, rather than having a separate biometric authentication server 275, communication staging server 255, electronic wallet server 265, and targeted offers server 245, certain embodiments may integrate such functional capabilities (or any portion thereof) into a single communication staging server 255. In other embodiments, product information such as product related codes, product name, unit price, etc. may be provided separately from the product taxonomy such that there may exist a separate master product file or database that contains the foregoing product attributes in addition to the product taxonomy database 215. Such embodiments provide flexibility for the merchant when choosing to provide sensitive merchant information to the IMS 165. Similarly, merchant loyalty program subcomponent 200 may exist and be managed by a third party entity different from the IMS 165 in some embodiments. In addition to supporting the generation, targeting and redemption of merchant based personal incentives, certain embodiments of an IMS 165 may also provide the manufacturers of products themselves (i.e., the CPGs 185) the capability of creating personal incentives and offer pools to be targeted to customers through the IMS 165. For example, similar to that provided to merchant employees, the IMS 165 may make a web interface available to CPG employees to create Impersonal incentives and offer pools to submit to the target engine 240 and ultimately to the customer targeted offer database 250 as targeted offers.

Enrollment in Merchant Loyalty Program

In an embodiment of the present invention, a customer may enroll in a merchant's loyalty program at a merchant location by providing personal information (such as name, address and phone number) to the IMS 165 (e.g., through the loyalty kiosk 170 or at the merchant's customer server desk) in order to obtain a merchant loyalty card containing a merchant loyalty identification number that can be used at the payment terminal 115 and/or ECR 110 at the merchant POS 105 during checkout. Such merchant loyalty identification number and personal information are stored in the customer information database 205 of the merchant loyalty program sub-opponent 200 of the IMS 165. Additionally or alternatively, further personal information may be submitted to the IMS 165 by the customer in order to create an electronic wallet to facilitate the purchasing of goods through biometric authentication at the merchant POS 105. Such further personal information may include, in addition to the merchant loyalty identification number, additional demographic information (e.g., name, age, gender, date of birth, address), verification information (e.g., biometric data, a password, a security question and answer pair), financial account information (e.g., credit account data, debit account data, checking account data), personal preferences (e.g., desired personal incentives distribution channels, default payment type, notifications of new personal incentives, etc.), healthcare information (e.g., policy number, insurance carrier, etc.), and any other personal and identity-related information. Such personal information (including the merchant loyalty identification number) may be stored in the electronic wallet database 270. The coustomer may additionally register identifying information for one or more personal devices, such as a mobile device, with the IMS 165 to view and activate his targeted offers through such personal devices. As previously discussed and depicted in FIG. 2, mobile identifying information such as the mobile device's phone number is stored in the device registration database 260 and is associated with a customer identifier such as the custommer's merchant loyalty identification number, so that customer's targeted offers may be identified in the customer targeted offers database 250 and transmitted to the mobile device.

Activation of Targeted Offers

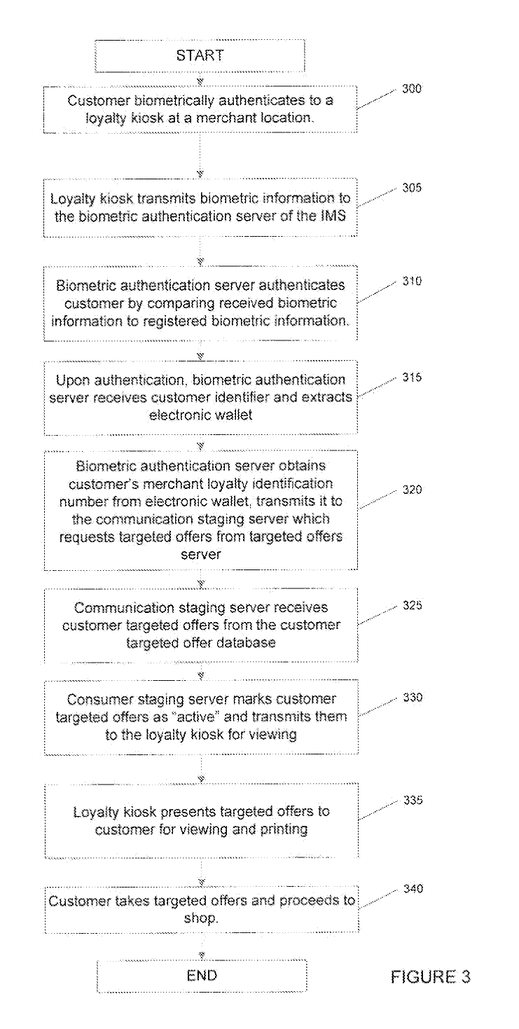

FIG. 3 depicts a flow chart for customer activation of targeted offers. As previously discussed in the context of FIG. 2, the merchant loyalty program subcomponent 200 regularly and continually feeds relevant data to the target engine data warehouse 235 and merchants regularly generate offer pools (e.g., through a web interface, etc.) that are transmitted to the targeting engine 240 in order to create targeted offers that are stored in the customer targeted offers database 250 awaiting “activation” by a customer. A customer may then activate his own targeted offers at any time by viewing the targeted offers through a variety of channels, such as through emails, via web browsing, by receiving messages at his registered mobile device and/or by visiting a merchant kiosk such as loyalty kiosk 170. In one biometrically enhanced embodiment, at step 300, prior to initiating his shopping experience, a customer may visit the loyalty kiosk 170, which may be conveniently situated near the entrance of the merchant and biometrically authenticate himself at the kiosk in order to view targeted offers associated with the customer's merchant specific loyalty identification number. The customer may place his finger on the biometric scanner on the loyalty kiosk 170 which then captures and produces a representation of the image of the customer's fingerprint. Additionally, the customer may also enter a personal number into the loyalty kiosk 170 to provide further information to the loyalty kiosk 170 in order to identify or verify the customer. At step 305, the loyalty kiosk 170 may transmit to the biometric authentication server 275 of the IMS 165 the customer's biometric information captured at step 300 (as well as a personal number of the customer, if entered by the customer) and request confirmation of the customer's identity by the IMS 165. At step 310, the biometric authentication server 275 receives the customer's biometric information (and personal number) and interacts with the biometric database 280 using known methods of comparing biometric in formation (and utilizing personal numbers) to confirm a successful biometric comparison and obtain a customer identifier (e.g., user identification number used internally in the IMS 165, etc.). In general. biometric comparisons are successful if the data sets of the compared biometric samples are sufficiently similar (i.e., they need not be identical). For example once the biometric authentication server 275 compares the received biometric data with stored biometric data, it can generate a result score indicative of the similarity of the data sets. If the result score meets the required matching threshold, the comparison can be considered successful.

At step 315, upon such biometric confirmation, the biometric authentication server 275 may receive the customer identifier from the authentication server 275 and forward it to the electronic wallet server 265 which then extracts the appropriate electronic wallet associated with the customer identifier from the electronic wallet database 270 and transmits it back to the biometric authentication server 275. At step 320, the biometric authentication server 276 may extract from the electronic wallet the customer's loyalty identification number specifically related to the merchant, forward the loyalty identification number to the communication staging server 255 which then transmits it to the targeted offers server 245 in order to obtain the customer's targeted offers. At step 325 the targeted offers server 245 queries the customer targeted offers database 250, obtains the customer's targeted offers, and transmits them back to the communication staging server 255. At step 330, the communication staging server 255 may mark the received customer's targeted offers as “activated” and ready to be consumed by the customer and transmits them to the loyalty kiosk 170. At step 335, the loyalty kiosk 170 may present the offers to the customer for viewing and may further print the set of offers for the customer to take with him during his shopping experience. In step 340, the customer may then proceed to shop at the merchant with his offers in hand. Those with ordinary skill in the art will recognize that alternative process Flows may be Implemented that do not depart from the spirit and scope of the foregoing disclosure. For example at step 320, the biometric authentication server 275 may forward the customer loyalty identification number or the electronic wallet itself back to the loyalty kiosk 170 which itself forwards the customer loyalty identification number (and if needed, extracts it from the electronic wallet) to the communication staging server 255. As previously discussed, those with ordinary skill in the art will recognize that certain embodiments may even integrate the functionality of the biometric authentication server 275 and the communication staging server 255 into a single consolidated communication staging server. Those with ordinary skill In the art will recognize that in alternative embodiments, for example, the loyalty kiosk 170 nay not be biometrically enabled but may present the offers to the customer if the customer enters his loyalty identification number, phone number or swipes his loyalty card or other identification card through a card reader coupled to the loyalty kiosk 170. In such scenarios, the customer's merchant loyalty identification number may be directly transmitted to the communication staging server 255 by the loyalty kiosk 170 such that the communication staging server 255 is able to forward such merchant loyalty identification number directly to the targeted offers server 245 to obtain the customer's targeted offers thereby bypassing the step of extracting such loyalty identification number from a retrieved electronic wallet as in steps 310 through to 320.

As previously discussed, customers may also activate their targeted merchant offers through other channels without using the loyalty kiosk 170 prior to visiting the merchant's store. For example, a customer may utilize his mobile device to initiate a communication session with the IMS 165 to retrieve his targeted offers. In such a scenario, communication staging server 255 may also include a mobile gateway to receive the mobile device's communication initiation request and identify the cellular number of the mobile device (e.g., through caller identification or text messaging identification techniques). The communication staging server 255 may then query the device registration database 260 to obtain a customer identifier related to the customer's registered mobile device. Once the communication staging server 255 obtains such a customer identifier, it is able to forward such an identifier to the electronic wallet server 265 to request the customer's electronic wallet from the electronic wallet database 270 and ultimately obtain the customer's loyalty identification numbers for any or all desired merchants. Similar to step 325, the communication staging server 255 is then able to obtain the customer's targeted offers through the targeted offers server 245 and foward such targeted offers to the mobile device for viewing and activation (e.g., through a URL, sent via a text message, that can be viewed by the mobile device's web browser or through a custom client viewing application residing on the mobile device). In an alternative embodiment, a customer may log into a merchant's web site by various alternative login methods (e.g., username and password, merchant loyalty identification number, biometrically, etc.). After obtaining the merchant loyalty identification number of the customer (e.g., either stored and accessible by merchant's web server after a customer login or by directly requesting the number after customer login), the merchant's web server may communicate with the communication staging server 255 in order to present the customer's targeted offers to the customer through the internet. Alternative Internet channels may also be envisioned, including, without limitation, having customers access a merchant's targeted offers through an identity management web portal offered by the IMS 165. Additionally, the availability of offers may also be communicated to customers through other distribution channels, such as email that, for example, may include an activation link that, when clicked, may open a new web page providing a view of the offers to the customer. Once a customer has viewed his offers, the communication staging server 255 may mark the offers as activated.

Targeted Offer Redemption

As further detailed in FIG. 4, at step 400, when a customer desires to complete a purchase of goods at the merchant, the customer places his finger on the BAP 120 which then captures and produces a representation of the image of the customer's fingerprint. Additionally, the customer may also enter a personal number into the PIN pad 115 to provide further information in order to identity or verify the customer. At step 405, the BAP 120 may transmit the customer's biometric information captured at step 400 (as well as a personal number of the customer, if entered by the customer) to the IMS 165 and request that the IMS 165 authenticate the customer with the customer's biometric information (and personal number). If in steps 410 through 425, similar to steps 310 to 325 during the activation of targeted offers, the biometric authentication server 275 of the IMS 165 is able to authenticate the customer such that the communication staging server 255 obtains the customer's targeted offers that have been activated through the process set forth in FIG. 3, then in step 430, the customer staging server 255 may export the activated targeted offers to the incentive redemption controller 140 located at the merchant in step 435, the biometric authentication server 275 may return a representation of the customer's electronic wallet that includes the customer's loyalty identification information and payment information (e.g., credit cards, debit cards, checking account, etc.) to the BAP 120. At step 440, the BAP 120 may extract the customer's loyalty information and payment information from the customer's electronic wallet and transmit such information to the PIN pad 115. At step 445, the PIN pad 115 may forward the payment information and loyalty information to the ECR 110. At step 450, when the merchant employee scans a product into the ECR 110, the ECR 110 may transmit the customer's loyalty information (e.g, loyalty identification number) and product information (e.g., UPC code) to the incentive redemption controller 140 which then determines whether such a product is eligible for a discount under the customer's activated targeted offers. If, at step 455, the incentive redemption controller 140 identifies that a product is eligible for a discount, it transmits the discount information to ECR 110 for deduction off the price charged to the customer. In certain embodiments, customer redemptions of activated target offers are tracked by the incentive redemption controller 140 and transmitted back to the IMS 165 for storage in the merchant loyalty program subcomponent 200 and subsequent use for improved targeting by the targeting engine 240 and/or to provide reports to the merchant In one embodiment wherein CPG activated offers are redeemed by the customer at the merchant POS 105 as described in the foregoing process, a report of such CPG redemptions may be generated by the IMS 165 and transmitted to the merchant for use during settlement of funds between the merchant and the CPG. Ultimately, payment information received by the ECR in step 445 is transmitted to a payment processor such as 155 and 160 for final payment authorization.

Those with ordinary skill in the art Will recognize that alternative process flows may be implemented that do not depart from the spirit and scope of the foregoing disclosure. For example, rather than transmitting the targeted offers to the incentive redemption server 140 at step 430, an alternative embodiment may transmit the targeted offers to the incentive redemption server 140 at step 330 in FIG. 3 during the activation process. Additionally, alternative embodiments of redeeming activated targeted offers at merchant locations may not necessarily utilize a biometrically enhanced merchant POS 105 as depicted in FIG. 1. For example those with ordinary skill in the art will recognize that a customer may slide or scan his merchant loyalty card through the payment terminal 115 and/or ECR 110 (or enter his loyalty number or other identification number such as a phone number into the payment terminal 115 and/or ECR 110) which will transmit the customer's merchant loyalty number directly to the communication staging server 255 of the IMS 165, thereby obviating the need for biometric authentication and extraction of the electronic wallet as described in steps 405 to 420. Instead, the communication staging server 255 may submit the customer's merchant loyalty identification number as received directly from the merchant POS 105 to the targeted offers server 245 to obtain the customer's targeted offers from the customer targeted offers database 250 which it then forwards to the incentive redemption controller 140 in step 430. In yet another embodiment, the incentive redemption controller 140 may be bypassed in its entirety, with the targeted offers obtained in step 425 being coupled with the electronic wallet that is transmitted to the BAP 120 in step 435. In such an embodiment, the BAP 120 may have the processing and memory capabilities to serve as an incentive redemption controller for the particular merchant POS 105 whereby the ECR 110 corresponds with the BAP 120 in steps 450 though 455.

Report Generation Capabilities

As previously discussed, IMS 165 may provide additional functionality to merchants, such as generating reports based on its tracking of redemptions and customer purchase history (e.g., through its receipt of t-logs through the, merchant loyalty program subcomponent 200). Collecting transaction and redemption data enables the IMS 165 to refine its targeting algorithms for creating targeted offers and provide merchants with, detailed reports of customer value and shopping behavior and analysis of the merchant's transaction activity. Such reports may include measures of customer retention, information pertaining to customer inventory (number of customers within different segments), information pertaining to customer segmentation relating to merchant sales, benchmark comparisons with other stores within a merchant chain, levels of customer identification, etc. and may reflect total merchant chain measures, division or region measures and/or individual merchant measures. Such reports may additionally enable the merchant to manually adjust his targeting preferences and/or supplement them by extending relevant incentives to specific customers that the reports indicate may be receptive. Those with ordinary skill in the art will recognize that reports generated by the IMS 165 may be delivered to merchants through a variety of distribution methods, including through the Internet (e.g., web reporting) allowing the merchant and all authorized personnel to view them via a web browser, or through a periodic publication sent to the merchant on a regular basis (i.e., weekly, monthly, quarterly). Such reports may integrate various observable factors, such as viewing types of sales (such as sales within a specific product category) across different customer segments. CPGs may also have authorized access to these same reports (product and customer category management) for their respective categories and products.

Although the present invention has been described will,the reference to the alternative embodiments, those of ordinary skill in the art will recognize that changes may be made in form and detail without departing from the spirit and scope of this disclosure. For example, the present invention has been described mainly with reference to analyzing personal incentives and creating targeted offers for an individual customer. However, those with ordinary skill in the art will recognize that the targeting engine 240 may analyze customer purchase habits and present targeted offers to customers based on a householding basis rather than on an individual basis. “Householding” as used herein refers generally to a method of consolidating or grouping information about any given person, family, household, company, friends, social network or other identified group. Techniques to utilize households across multiple merchants as disclosed and taught in U.S. patent application Ser. No. 11/421,458 may be implemented in conjunction with the teachings herein. Similarly, while the present invention has primarily discussed personal incentive in the form, of discount offers to customers, certain embodiments may also enable personal incentives in the form of advertisements. For example, a CPG may desire to determine which customers are the best to target for certain advertisements (as opposed to offers). Targeted CPG advertisements, may for example, be printed out in the sheet of offers that are given to the customer during step 335 of FIG. 3. The present invention has also mainly been described with reference to a “bricks and mortar” merchant infrastructure as described in FIG. 1. Howevever, those with ordinary skill in the art will recognize that other merchant channels such as, but not limited to, an online or e-commerce transaction architecture or a mobile device transactions architecture could also make use of the claimed invention (e.g., merchant-specific loyalty identification information could be tracked by the merchant in a similar manner as discussed herein in such architectures). Similarly, the present invention has been primarily described with reference to a biometrically enhanced payment infrastructure, and those of ordinary skill in the art will recognize that non-biometrically enhanced payment infrastructures similar in spirit to that described in FIG. 1 may also serve to support the present invention. Terminology used in the foregoing description is for the purpose of describing the particular versions or embodiments only, and is not intended to limit the scope of the present invention which will be limited only by the appended claims. As used herein and in the appended claims, the singular forms “a,” “an,” and “the” include plural references unless the context clearly dictates otherwise. Similarly, the words “for example”, “such as”, “include,” “includes” and “including” when used herein shall be deemed in each case to be followed by the words “without limitation.” Unless defined otherwise herein all technical and scientific terms used herein have the same meanings as commonly understood by one of ordinary skill in the art. All publications mentioned herein are incorporated by reference. Nothing herein is to be construed as an admission that the embodiments disclosed herein are not entitled to antedate such disclosure by virtue of prior invention. Thus, various modifications additions and substitutions and the like can be made without departing from the spirit of the invention and these are therefore considered to be within the scope of the invention as defined in the following claims.

What is claimed is:

1. A method for redeeming targeted offers for a customer at a merchant location, the method comprising:
obtaining a merchant loyalty identifier relating to the customer;
locating in a database a set of personal incentives targeted for the customer;
transmitting data elements relating to each personal incentive in the set to a redemption controller located at the merchant location;
receiving at the redemption controller a product code relating to a product scanned at a merchant point of sale;
determining at the redemption controller whether the product code matches any of the data elements for any personal incentive in the set; and
transmitting discount information relating to the product to the merchant point of sale.

2. The method of claim 1 further comprising:
receiving a biometric sample of the customer from the merchant point of sale;
obtaining a customer identifier upon a successful comparison of the biometric sample with a registered biometric sample relating to the customer;
extracting an electronic wallet associated with the customer identifier; and
extracting the merchant loyalty identifier from the electronic wallet.

3. The method of claim 1 wherein the merchant loyalty identifier relates to a household of which the customer is a member.

4. The method of claim 1 wherein the data elements for each personal incentive include a UPC code and a discount amount.

5. The method of claim 4 wherein the product code relating to the scanned product is a UPC code.

6. The method of claim 1 further comprising receiving at the redemption controller redemption information from the merchant point of sale upon discounting the scanned product.

7. A method for activating targeted offers for a customer, the method comprising:
obtaining a merchant loyalty identifier relating to the customer;
locating in a database a set of personal incentives targeted for the customer;
transmitting information relating to each personal incentive in the set to a customer display; and
marking the personal incentives in the set as activated.

8. The method of claim 7 further comprising:
receiving a biometric sample of the customer from the customer display;
obtaining a customer identifier upon a successful comparison of the biometric sample with a registered biometric sample relating to the customer;
extracting an electronic wallet associated with the customer identifier; and
extracting the merchant loyalty identifier from the electronic wallet.

9. The method of claim 7 wherein the customer display is a loyalty kiosk at a merchant location.

10. The method of claim 7 wherein the customer display is a web browser on an online terminal.

11. The method of claim 7 wherein the customer display is a display of a mobile device.

12. The method of claim 11 further comprising:
receiving a mobile identifier from the mobile device; and
extracting the merchant loyalty identifier related to the mobile identifier from a device registration database.

13. The method of claim 12 wherein the mobile identifier is a mobile phone number.

14. The method of claim 7 wherein the transmitted information relating to each personal incentive in the set includes a discount amount, a product code a description of the product, and a display image of the product.

15. A batch process for generating targeted offers for customers, the process comprising:
storing merchant information received from a merchant on a periodic basis in a data warehouse;
receiving a pool of personal incentives from the merchant;
transmitting the pool of personal incentives to a targeting engine coupled to the data warehouse;
generating targeted offers for customers based upon characteristics of each of the personal incentives in the pool and the merchant information stored in the data warehouse; and
storing the targeted offers in a database for future activation by customers.

16. The method of claim 15 wherein the merchant information received from the merchant includes one or more of customer loyalty information, product taxonomy information, customer segmentation information, redemption information and transaction log information.

17. The method of claim 15 wherein the characteristics of each personal incentive include one or more of a product code, discount amount, customer limit, distribution limit, customer segment requirement, and targeting strategy.

18. The method of claim 15 wherein the personal incentives in the pool have a common effective date, expiration date, and targeting date.

19. The method of claim 15 wherein transmitting the pool of personal incentives to the targeting engine automatically occurs on a particular targeting date.

20. An incentive management systen to facilitate the distribution and redemption of personal incentives to customers, the incentive management system comprising:
a merchant loyalty program subcomponent for storing merchant information relating to a merchant loyalty program;
a communication staging server for transmitting personal incentives to customers for activation and for transmitting personal incentives to a redemption controller at a merchant location to facilitate redemption by customers;
a targeting engine for generating targeted offers of personal incentives for customers based upon analysis of the characteristics of the personal incentives and the merchant information stored by the merchant loyalty program; and
a targeted offers database for storing the targeted offers generated by the targeting engine.

21. The incentive management system of claim 20, further comprising:
a biometric database for storing registered biometric samples of customers;
a biometric authentication server coupled to the biometric database to retrieve customer authentication information;
an electronic wallet database for storing electronic wallets associated with customers; and
an electronic wallet server coupled to the electronic wallet database to retrieve electronic wallets.

22. The incentive management system of claim 20 further comprising a device registration database storing device identifiers associated with customers.

23. The incentive management system of claim 20 wherein the merchant information relating to a merchant loyalty program includes one or more of customer loyalty information, product taxonomy information, customer segmentation information, redemption information and t-log information.

24. The incentive management system of claim 20 wherein the merchant loyalty program subcomponent comprises one or more of a product taxonomy database, customer information database, merchant transaction logs database, customer segmentation database, and offer database to store pools of personal incentives created by merchants.
